(19) United States
(12) Patent Application Publication
(10) Pub. No.: US 2008/0153998 A1
(43) Pub. Date: Jun. 26, 2008

(54) MODIFIED CATALYSTS FOR IMPROVED POLYMER PROPERTIES

(75) Inventors: Ricky McCormick, Sealy, TX (US); David W. Knoeppel, League City, TX (US); Steven D. Gray, Bellaire, TX (US); Tim J. Coffy, Houston, TX (US)

Correspondence Address: FINA TECHNOLOGY INC, PO BOX 674412, HOUSTON, TX, 77267-4412, US

(73) Assignee: FINA TECHNOLOGY, INC., HOUSTON, TX (US)

(21) Appl. No.: 11/613,766

(22) Filed: Dec. 20, 2006

(51) Int. Cl. B01J 31/14; C08F 4/22; B01J 21/02; B01J 21/08

(52) U.S. Cl. 526/90; 502/204; 502/320; 502/242; 502/152

(57) ABSTRACT

Chromium catalysts may be prepared using a process including contacting a chromium catalyst precursor with a treatment agent. This catalyst may be used for polymerization of a variety of monomers, particularly olefins, to form polymers for a wide variety of applications. The catalyst exhibits desirable activity rates and polymers produced therewith may exhibit improved melt flow, polydisperity values, and changes in shear thinning as compared to those prepared under similar conditions but using the same treatment agent as a cocatalyst instead.

### BACKGROUND OF THE INVENTION

1. Technical Field

This invention relates to polymers. More particularly, it relates to pre-activation modifiers for certain catalysts useful for preparing polymers.

2. Background of the Art

Advances in polymerization and catalysis have resulted in the capability to produce many new polymers having improved physical and chemical properties useful in a wide variety of superior products and applications. With the development of new catalysts the choice of polymerization (solution, slurry, high pressure or gas phase) for producing a particular polymer has been greatly expanded. Also, advances in polymerization technology have provided more efficient, highly productive and economically enhanced processes.

Among the many types of catalysts are the so-called conventional transition metal catalysts. These catalysts may be generally described as including traditional Ziegler-Natta, vanadium and the so-called Phillips-type catalysts. The Phillips-type catalysts are those based on chromium, hereinafter chromium catalysts. As a general rule these catalysts, along with the other types of conventional catalysts, may be combined with cocatalysts in order to produce a desired polymerization efficiency. While a wide variety of cocatalysts have been discovered to be effective, a number do not necessarily work well with chromium catalysts. Furthermore, even where they have been shown to be relatively effective at promoting the polymerization, as is the case with certain boron compounds such as triphenyl boron, their use may result in a polymer with significantly altered melt flows. Also, as the boron level rises, polydispersity may be adversely affected. While there may be instances where these properties alterations are desired, there are also instances where they are considered to be counterproductive.

### SUMMARY OF THE INVENTION

In one aspect, the invention is a process for preparing a chromium pre-catalyst including admixing a chromium catalyst precursor with a treatment agent to form a pre-catalyst wherein the treatment agent is selected from the group consisting of an aluminum treatment agent, a boron treatment agent, and mixtures thereof.

In another aspect, the invention is a process for preparing a polymer including contacting a chromium catalyst precursor with a treatment agent to form a precatalyst; activating the precatalyst to form a chromium catalyst; and contacting at least one monomer with the chromium catalyst to form a polymer, wherein the treatment agent is selected from the group consisting of an aluminum treatment agent, a boron treatment agent, and mixtures thereof.

In still another aspect, the invention is a polymer prepared by a process for preparing a polymer including contacting a chromium catalyst precursor with a treatment agent to form a precatalyst; activating the precatalyst to form a chromium catalyst; and contacting at least one monomer with the chromium catalyst to form a polymer, wherein the treatment agent is selected from the group consisting of an aluminum treatment agent, a boron treatment agent, and mixtures thereof.

In another aspect, the invention is an article of manufacture prepared from a polymer prepared by a process for preparing a polymer including contacting a chromium catalyst precursor with a treatment agent to form a precatalyst; activating the precatalyst to form a chromium catalyst; and contacting at least one monomer with the chromium catalyst to form a polymer, wherein the treatment agent is selected from the group consisting of an aluminum treatment agent, a boron treatment agent, and mixtures thereof.

### DETAILED DESCRIPTION OF THE INVENTION

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology. Various terms as used herein are shown below. To the extent a term used in a claim is not defined below, it should be given the broadest definition persons in the pertinent art have given that term as reflected in printed publications and issued patents.

Conventional chromium catalysts may include a variety of chromium compounds. Examples of these compounds are chromium oxide (CrO₃), chromocene, silyl chromate, chromyl chloride (CrO₂Cl₂), chromium-2-ethyl-hexanoate, chromous bromide, chromic bromide, chromous chloride, chromic chloride, chromous fluoride, chromic fluoride, chromium acetylacetonate, mixtures thereof, and the like. Cyclic compounds may also be used. Non-limiting examples are also disclosed in U.S. Pat. Nos. 3,709,853; 3,709,954; 3,231,550; 3,242,099; and 4,077,904; all of which are fully incorporated herein by reference in their entireties. Examples of commercially available catalyst precursors that are suitable for use in this invention include, but are not limited to those sold by Grace Davison, Basell, Ineos Silicas, and PQ Corporation.

Preparation and use of the starting chromium precursors described hereinabove may be by any means known to those skilled in the art and may vary according to the desired catalyst being prepared. For example, the methods of U.S. Pat. Nos. 6,833,416 and 6,921,798 may be used and these patents are fully incorporated by reference.

It is a feature of the invention that a modified chromium catalyst may be prepared, prior to any catalyst activation, by contacting a chromium catalyst precursor with a treatment agent. As used herein “catalyst precursor” is defined as any compound which may be activated to form a chromium catalyst capable of polymerizing olefins. Suitable chromium catalyst precursors may include compounds of trivalent chromium. For example, one group of catalyst precursors are salts of chromium (III) with an organic or inorganic acid, e.g. acetates, oxalates, sulfates, nitrates. Any chromium (III) compound which may be activated to form chromium catalysts capable of polymerizing olefins may be used with the invention and specifically included in this group of compounds are those that are supported on silica and the like.

The treatment agents may be boron treatment agents, aluminum treatment agents and mixtures thereof. The treatment agents may have the general formula:

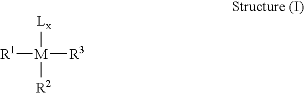

wherein M is aluminum or boron; L is a Lewis base; and X is 0 or 1. The R¹, R², R³ groups may be the same or different and may be selected from the group consisting of: alkyl, aryl, and alkoxy moieties having from 3 to 15 carbons; halogens; hydroxy groups; oxy groups; hydrogen and combinations thereof. When X=0, at least one of R¹, R², and R³ is not hydrogen if M is aluminum. Two or more of R¹, R², and R³ may be incorporated into a cyclic structure that may or may not include additional aluminum or boron atoms.

For the purposes of this patent application, Lewis bases are organic compounds which may be capable of donating an electron pair to the treatment agent. Exemplary Lewis bases are organic compounds containing oxygen, nitrogen, phosphorous, or sulfur.

The treatment agents may include cyclic compounds that incorporate the general structure above such as, for example, trimethylboroxine which has the structure:

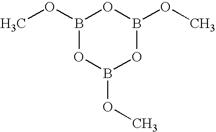

where the structure at every boron meets the definition of the general Structure (I). In some embodiments having more than one aluminum and/or boron atom, not all of the boron or aluminum atoms may meet every requirement of the general Structure (I).

The “boron” treatment agents may be selected from a wide variety of boron-containing compounds including: triethyl boron (TEB), boric acid, trimethoxy borate (B(OMe)₃), trimethylboroxine (B₃O₆Me₃), triphenyl boron, triethyl boron, trifluoroboron, triethoxy borate, boric acid, triethylboroxine and mixtures thereof. Any boron compounds having the general structure of Structure (I) may be used with the invention. For example, in one embodiment, the boron modifying agent may be Et₂OBH₃.

The aluminum treatment agents may similarly be selected from a wide variety of aluminum compounds. For example, in one embodiment, the aluminum treatment agents may be selected from the group consisting of triethyl aluminum (TEAI), trimethyl aluminum (TMA), triisobutyl aluminum (TIBAI) and combinations thereof. In another embodiment, the aluminum treatment agent may be tri-n-hexylaluminum, tri-n-octylaluminum, tri-iso-octylaluminum, triphenylaluminum, and combinations thereof. Triethoxyaluminium may also be used as the treatment agent. Methylaluminoxane may also be used as the treatment agent. Any aluminum compounds having the general structure of Structure (I) may be used with the invention.

Another class of compounds which may be used as a boron treating agent of the invention is the boron hydrides. BH₃, which commonly has the form of B₂H₆, may be used as a boron treating agent of the invention. Other oligomers of boron hydride may also be used.

To accomplish the preparation of the chromium catalyst of the invention, the selected chromium catalyst precursor may be contacted with the selected treatment agent to prepare a pre-catalyst. In some embodiments it may be desirable to first subject the catalyst precursor to one or more drying steps in order to reduce or, desirably, substantially eliminate the presence of any water that may be present. For example, such may be accomplished under elevated temperature under a nitrogen atmosphere, optionally in a fluidized bed. In some embodiments the temperature may range from about 25° C. to about 150° C., and in other embodiments from about 70° C. to about 90° C. Other possible drying steps may include any known to those of ordinary skill in the art of preparing catalysts to be useful for preparing such catalysts.

The contacting of the chromium catalyst and selected treatment agent may also be accomplished under a nitrogen or other inert and essentially water-free environment. For example, the dried catalyst precursor may be contacted with a solution of the treatment agent in an organic liquid medium, such as, for example, hexane, isobutane, pentane, heptane, and the like. The solution may be of a concentration sufficient to achieve a desired proportion of incorporation of the treatment agent.

Following preparation of the pre-catalyst, it may be desirable to activate the pre-catalyst to form a catalyst. Activation generally involves any treatment, whether of a physical or chemical nature, that results in a chemical change in the catalyst that makes it capable or more capable of undergoing the atomic transfers that result in polymerization of olefins. Simple activation may be accomplished in some embodiments by simply subjecting the catalyst, which has now been modified, to elevated temperature. In the case of the selected chromium catalysts that have been modified by the boron modifying agent, it may be effective in some embodiments to heat the catalyst to a temperature in excess of 200° C., and in other embodiments a temperature of from about 300° C. to about 1050° C. may be suitable. In still other embodiments, a temperature from about 400° C. to about 800° C. may be employed. Temperature ramping may be important, such as in a tube furnace under an inert atmosphere. Since activation requires oxidation, then air may be used during activation for oxidation. Those skilled in the art will be aware of applicable activation protocols that may be described as conventionally prescribed for the selected chromium-based starting catalysts, which may be equally useful for the corresponding boron-modified catalysts.

The catalysts of the invention may be further treated using a reducing compound and/or a scavenger. Compounds useful with the invention for this function may include triaryl boron, trialkyl boron, trialkyl aluminum, alumoxanes, and modified alumoxanes. A variety of methods for preparing alumoxanes and modified alumoxanes are described in non-limiting examples in U.S. Pat. Nos. 4,665,208; 4,952,540; 5,091,352; 5,206,199; 5,204,419; 4,874,734; 4,924,018; 4,908,463; 4,968,827; 5,308,815; 5,329,032; 5,248,801; 5,235,081, 5,157,137; 5,103,031; 5,391,793; 5,391,529; 5,041,584; 5,693,838, 5,731,253; 5,041,584; and 5,731,451; and European publications EP-A-0 561 476; EP-B1-0 279 586; and EP-A-0 594 218; and PCT publication WO 94/10180; all of which are fully incorporated herein by reference in their entireties.

It is noted that in some embodiments the catalyst and/or the activator may be placed on, deposited on, contacted with, incorporated within, adsorbed or absorbed in a support. Typically the support may be of any of the solid, porous supports, including microporous supports. Typical support materials include Al(PO₄)₃ talc; inorganic oxides such as silica, magnesium chloride, alumina, silica-alumina; silica-titania, silica-titania-alumina, and the like; combinations thereof; and the like. Desirably, the support may be used in a finely divided form.

For example, inorganic oxides that include Groups 2, 3, 4, 5, 13 and 14 metals, may be used as supports. These include, for example, silica, fumed silica, alumina, such as is taught in WO 99/60033 and which reference is fully incorporated herein by reference; silica-alumina and mixtures thereof. Also included are magnesia, titania, zirconia, magnesium chloride, montmorillonite, phyllosilicate, zeolites, talc, clays, and the like, as taught in U.S. Pat. No. 5,965,477; European Patent No. EP-B1-0 511 665; and U.S. Pat. No. 6,034,187; all of which references are fully incorporated herein by reference. Combinations of these support materials may also be used, as described in European Patent No. EP-B1-0 767 184, which is fully incorporated herein by reference. Other support materials include nanocomposites as described in PCT WO 99/47598, aerogels as described in WO 99/48605, spherulites as described in U.S. Pat. No. 5,972,510, and polymeric beads as described in WO 99/50311, all of which are fully incorporated herein by reference in their entireties. In one embodiment a selected support is fumed silica, such as the one available under the trade name CABOSIL^{R} TS-610 from Cabot Corporation. Fumed silica is typically a silica with particles of 7 to 30 nanometers in size that has been treated with dimethylsilyidichloride such that a majority of hydroxyl groups are capped.

In some embodiments, the support material may have a surface area in the range of from about 10 m²/g to about 700 m²/g, a pore volume in the range of from about 0.1 cc/g to about 4.0 cc/g, and an average particle size in the range of from about 5 μm to about 500 μm. In some embodiments the surface area of the support may be from about 50 to about 500 m²/g, the pore volume may be from about 0.5 cc/g to about 3.5 cc/g, and the average particle size may be from about 10 μm to about 200 μm. In other embodiments the surface area of the support may be in the range of from about 100 m²/g to about 1000 m²/g, the pore volume may be from about 0.8 cc/g to about 5.0 cc/g, and the average particle size may be from about 5 μm to about 100 μm. The average pore size of the support materials may, in some embodiments, range from about 10 Angstroms to about 1000 Angstroms; in other embodiments from about 50 Angstroms to about 500 Angstroms; and in still other embodiments from about 75 Angstroms to about 350 Angstroms.

Prior to use, the support material may be partially or completely dehydrated. The dehydration may be done physically by calcining or by chemically converting all or part of the active hydroxyls to other groups.

In one embodiment an activator may be contacted with a support to form a supported activator, wherein the activator is deposited on, contacted with, vaporized with, bonded to, or incorporated within, adsorbed or absorbed in, or on, a support or a carrier. Dehydration may be carried out at a temperature of, for example, from about 100° C. to about 600° C., after which the activator and/or catalyst is allowed to contact the support material.

In another embodiment, a Lewis base-containing support reacts with a Lewis acidic activator to form a support bonded Lewis acid compound. The Lewis base hydroxyl groups of silica are exemplary of the metal/metalloid oxides wherein this method of bonding to a support occurs. Various embodiments of a supported activator may be found in, for example, U.S. Pat. No. 5,288,677, which reference is fully incorporated by reference.

In another embodiment, the chromium catalyst and/or the selected activator may be combined with a support material such as a particulate filler material which is then spray dried to form a free flowing powder. Spray drying may be by any means known in the art, such as are described in, for example, EP-B1-0 668 295; and U.S. Pat. Nos. 5,674,795 and 5,672,669, which references are fully incorporated herein by reference. In one embodiment, the chromium catalyst and the optional activator may be placed in solution, allowing the catalyst and activator to react, if desired; a filler material, such as silica or fumed silica, is added; and the solution is then forced at high pressures through a nozzle. The solution may be sprayed onto a surface or sprayed such that the droplets dry in mid-air. The method generally employed is to disperse the silica in toluene, stir in the selected activator solution, then stir in the chromium catalyst solution. Typical slurry concentrations are from about 5 to about 8 percent by weight. This formulation may sit as a slurry for as long as 30 minutes with mild stirring or manual shaking in order to keep it as a suspension, prior to spray-drying. In one embodiment, the makeup of the dried material may be about 40 to about 50 weight percent activator, e.g., alumoxane; 48 to about 58 weight percent SiO₂; and about 2 weight percent of chromium catalyst, e.g., chromium acetylacetonate ([CH₃COCHC(CH₃)0]₃Cr).

The proportion of the optional activator, where selected, to the support material may be from about 10 to about 70 weight percent, based on the weight of the support, and in some embodiments may be from about 20 to about 60 weight percent. In other embodiments a level of from about 30 to about 50 weight percent may be employed, and in still other embodiments a proportion of activator ranging from about 30 to about 40 weight percent may be used.

In general, then, the combination of the boron- and/or aluminum-modified, chromium catalyst, the activator (if selected), and the support may occur in any order. In one embodiment, once the activator is supported, it may be then combined with the chromium catalyst to form a supported catalyst system. Similarly, the chromium catalyst may be placed on or otherwise supported first, for example tethered there by a covalent linkage, and thereafter the optional activator may be added to form the supported catalyst system. In another embodiment the boron- and/or aluminum-modified, chromium catalyst and the optional activator are first combined, then placed on the support.

In one embodiment the invention may be directed toward any polymerization or copolymerization reactions involving the polymerization of one or more monomers having from 2 to 30 carbon atoms, in another embodiment 2 to 12 carbon atoms, and in a further embodiment 2 to 8 carbon atoms, using a chromium catalyst. For the purposes of this application, the term “monomer” means a quantity of a monomer. Polymerizing one or more monomers means polymerizing a quantity of at least one but perhaps more than one monomer type to prepare a polymer or copolymer.

The invention may be particularly well suited to the copolymerization reactions involving the polymerization of one or more olefin monomers of ethylene, propylene, butene-1, pentene-1, 4-methyl-pentene-1, hexene-1, octene-1, decene-1, 3-methyl-pentene-1; 3,5,5-trimethyl-hexene-1, cyclic olefins, and combinations thereof. Other monomers include vinyl monomers; diolefins such as dienes; polyenes; norbornenes; and norbornadienes. In some embodiments a copolymer of ethylene is produced, wherein the comonomer is at least one alpha-olefin having from 3 to 15 carbon atoms, in some embodiments from 3 to 12, in other embodiments from 3 to 7 carbon atoms. In one alternate embodiment, the disubstituted olefins disclosed in WO 98/37109 may be polymerized or copolymerized according to the invention.

In another embodiment ethylene or propylene may be polymerized with at least two different comonomers to form a terpolymer. In certain embodiments the comonomers are a combination of alpha-olefin monomers having from 4 to 10 carbon atoms, in other embodiments from 4 to 8 carbon atoms, optionally with at least one diene monomer. Example of suitable terpolymers include combinations such as ethylene/-butene-1/hexene-1, ethylene/propylene/butene-1, propylene/ethylene/hexene-1, ethylene/propylene/norbornene, and the like.

The invention may be useful in a solution, gas or slurry process. For example, in a gas phase polymerization a continuous cycle is employed wherein, in one part of the cycle of a reactor system, a cycling gas stream, otherwise known as a recycle stream or fluidizing medium, may be heated in the reactor by the heat of polymerization. This heat may be removed from the recycle composition in another part of the cycle by a cooling system external to the reactor. Generally, in a gas fluidized bed process for producing polymers, a gaseous stream containing one or more monomers may be continuously cycled through a fluidized bed in the presence of a catalyst under reactive conditions. The gaseous stream may be withdrawn from the fluidized bed and recycled back into the reactor. Simultaneously, the polymer product may be withdrawn from the reactor and fresh monomer may be added to replace the polymerized monomer. See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference in their entirety.

The reactor temperature in a gas phase process may vary from about 30° C. to about 120° C., and in some embodiments from about 60° C. to about 115° C. In other embodiments it may range from about 7° C. to about 110° C., and in still other embodiments from about 7° C. to about 95° C.

In such gas phase polymerization, the productivity of the chromium catalyst or catalyst system, including any chemical activator and/or support, may be influenced by the primary monomer's partial pressure. In some embodiments the mole percent of the main monomer, for example, ethylene or propylene, may be from about 25 to about 90 mole percent, and the monomer partial pressure may be from about 75 psig (517 kPa) to about 300 psig (2069 kPa).

Other gas phase processes contemplated for use with the invention include those described in U.S. Pat. Nos. 5,627,242; 5,665,818; and 5,677,375; and European publications EP-A-0 794 200; EP-A-0 802 202; and EP-B-0 634 421; all of which are fully incorporated by reference herein in their entireties.

A slurry polymerization process may, in some embodiments, be employed. In this case it may use pressures from about 1 to about 50 atmospheres or greater, and temperatures from about 0° C. to about 120° C. In a slurry polymerization, a suspension of solid, particulate polymer may be formed in a liquid polymerization diluent medium to which a monomer, for example, ethylene and, in some embodiments, one or more selected comonomers, may be added, along with hydrogen and the boron- and/or aluminum-modified, chromium catalyst. The suspension, including diluent, may be intermittently or continuously removed from the reactor where the volatile components are separated from the polymer and recycled, optionally after a distillation, to the reactor. The liquid diluent employed in the polymerization medium is, in some embodiments, an alkane having from 3 to 7 carbon atoms, and is, in other embodiments, a branched alkane. The medium employed may be liquid under the polymerization conditions and may be also relatively inert.

In one embodiment, a slurry process may be performed wherein the temperature is kept below the temperature at which the polymer goes into solution. Such a technique is well known in the art, and is described in, for instance, U.S. Pat. No. 3,248,179, which is fully incorporated herein by reference in its entirety. The preferred temperature for this process is within the range of from about 85° C. to about 110° C. Two preferred polymerization methods for the slurry process are those employing a loop reactor, and those utilizing a plurality of loop or stirred reactors in series, parallel, or a combination thereof. Non-limiting examples of slurry processes also include stirred tank processes. Also, other examples of slurry processes are described in, for example, U.S. Pat. No. 4,613,484, which is fully incorporated herein by reference in its entirety.

In another embodiment, the slurry process may be carried out continuously in a loop reactor. The catalyst, as a slurry in isobutane, for example, or as a dry free flowing powder, is injected regularly or periodically into the reactor loop, which is itself filled with a circulating slurry of growing polymer particles in a diluent of isobutane which contains monomer and, if applicable, comonomer. Hydrogen may be added as a molecular weight control. The reactor is maintained at a pressure of from about 525 psig to 625 psig (3620 kPa to 4309 kPa) and at a temperature in the range of from about 60° C. to about 104° C., depending on the desired polymer density. Reaction heat is removed through the loop wall, since much of the reactor is in the form of a double-jacketed pipe. The slurry is allowed to exit the reactor, at regular intervals or continuously, to a heated low pressure flash vessel, rotary dryer and a nitrogen purge column, in sequence, for example, for removal of the isobutane diluent and all unreacted monomer and comonomers. The resulting polymer powder may be then compounded for use in various applications.

In an embodiment in the slurry process the total reactor pressure may range from about 400 psig (2758 kPa) to 800 psig (5516 kPa), and in another embodiment from about 450 psig (3103 kPa) to about 700 psig (4827 kPa). In still other embodiments the reactor pressure may range from about 500 psig (3448 kPa) to about 650 psig (4482 kPa), and in further embodiments from about 525 psig (3620 kPa) to 625 psig (4309 kPa).

Solution processes may also be used with the catalysts of the invention. Examples of solution processes are described in, for example, U.S. Pat. Nos. 4,271,060; 5,001,205; 5,236,998; and 5,589,555; which are fully incorporated herein by reference in their entireties. In general, such processes involve the polymerization of monomers in an inert liquid medium in the presence of a coordination catalyst, which operates at temperatures above the melting or solubilization temperature of the polymer. In a solution process, both the monomer and polymer are soluble in the reaction medium. A degree of control over the degree of polymerization, and hence the molecular weight and molecular weight distribution of the polymer obtained, may be frequently attained by control of the temperature conversion in the reactor system.

The result of polymerization, regardless of the polymerization method used, may be a polymer having, in certain embodiments, a useful melt flow, as measured by ASTM D-1238, Condition E, at 190° C. of at least 1.0 g/10 minutes of HLMI and in further embodiments from about 3 g/10 minutes to 75 g/10 minutes. In some embodiments the HLMI value may be from about 10 g/10 minutes to 50 g/10 minutes, and in other embodiments it may be from 15 g/10 minutes to 30 g/10 minutes.

The molecular weight distribution (MWD) of the polymer may also be affected by the modification of the chromium catalyst of the invention but generally, in most embodiments, the boron and/or aluminum modifications result in a polymer where the MWD is unchanged in comparison to a similar polymer prepared with an unmodified catalyst.

In one embodiment, the process of the invention includes the ordered steps of (1) contacting a chromium catalyst precursor with a treatment agent to form a precatalyst; (2) activating the precatalyst to form a chromium catalyst; and (3) contacting at least one monomer with the chromium catalyst to form a polymer. One advantage of some embodiments of the invention is improvements in physical properties of polymers prepared with catalysts that were so prepared. These improvements are observed, in some embodiments, in comparison to a similar polymer made using a similar catalyst that was not contacted with a treatment agent prior to activation. In other embodiments, the improvements are observed in comparison to polymers prepared using the treatment agent as a co-catalyst instead of a treatment agent.

The polymers of the invention may be made into a wide variety of intermediary and end-use articles, including, for example, single-layer and multi-layer films, molded articles, sheets, wire and cable coating, and the like. Films may be formed by any of the techniques known in the art including extrusion, co-extrusion, lamination, blowing and casting. The film may be obtained by a flat film or tubular process, which may be followed by orientation in a uniaxial direction or in two mutually perpendicular directions in the plane of the film to the same or different extents. Orientation may be to the same extent in both directions, or may be to different extents in both directions. Also included are methods to form polymers into films by extrusion or co-extrusion on a blown or cast film line.

In these and other applications the polymer may be combined with a number of polymer-modifying additives and/or reactants to achieve desired properties including appearance, strength and other performance variables. For example, additives including slip agents, anti-block agents, antioxidants, pigments, fillers, anti-fog agents, UV stabilizers, antistatic agents, polymer processing aids, neutralizers, lubricants, surfactants, dyes, and nucleating agents may be employed. Among such additives are, for example, silicon dioxide, synthetic silica, titanium dioxide, polydimethylsiloxane, calcium carbonate, metal stearates such as calcium stearate and zinc stearate, talc, barium sulfate, diatomaceous earth, waxes, carbon black, flame retarding additives, low molecular weight resins, hydrocarbon resins, glass beads and the like. Additives of these and other types may be present, in many embodiments, in any amounts known to be effective or desirable in the art, frequently ranging in polymer formulations from about 0.001 percent by weight to about 10 percent by weight, based on the polymer.

The following examples are provided to more fully illustrate the invention. As such, they are intended to be merely illustrative and should not be construed as being limitative of the scope of the invention in any way. Those skilled in the art will appreciate that modifications may be made to the invention as described without altering its scope. For example, selection of particular starting materials in preparing the chromium catalyst or the boron modifying agent, or in the polymerization in which the modified catalyst is employed; intermediate products; reaction and process variables such as feed rate, processing temperatures, pressures and other conditions; and the like; not explicitly mentioned herein but falling within the general description hereof, will still fall within the intended scope of both the specification and claims appended hereto.

### EXAMPLES

### Example 1

### Boron Modification (I)

A silica titania chromium catalyst precursor was dried at 100° C. in a fluidized bed under a nitrogen atmosphere to remove excess water. Under a nitrogen purge, the dried precursor sample was then treated with a boron treating agent by contacting the precursor with a 1M solution of triethyl boron in hexane in order to achieve levels of boron incorporation equal to 0.5 and 1.0 weight percent, respectively. These treated precursor samples, as well as a sample of the chromium catalyst without boron modification (control), were then activated by heating, in 25 gram lots, in a tube furnace under a nitrogen flow.

A soak temperature (a temperature at which the samples are held) of 400° C. to 1000° C. was selected. The treated precursor samples and control were heated to 120° C. and held at that temperature for ninety minutes. Following this, the temperature was ramped up to 100° F. (55° C.) below the soak temperature over a 5.5 hour period. At this point the gas flow was switched to air. The temperature was then ramped to the soak temperature over a period of one hour and held there for 6 hours. Finally, power to the heaters was stopped. When the treated samples and control reached 400° C., the treated samples and control were cooled under nitrogen to room temperature.

The boron modified catalyst was then used in a 4 liter Autoclave Engineer bench reactor having four mixing baffles with two opposed pitch propellers for ethylene polymerization using the conditions shown in Table 1. The hexene, when used, was added as an aliquot and not continuously.

TABLE 1

| Diluent | Isobutane |
|---|---|
| Target Productivity (g PE/g catalyst) | 1000 |
| Temperature (° C.) | 104 |
| Ethylene Concentration (Wt. %) | 8 |
| Hexene Concentration (Wt. %) | 0, 0.36 |

The activity of the catalyst, measured as g PE/g catalyst/hr, was tested and compared with the level of hexene. Melt flow was also tested, as HLMI (ASTM D1238), MI₂ (2.16 kg weight-ASTM D1238) and MI₅ (5 kg weight-ASTM D1238). These results are shown in Table 2.

TABLE 2

| | | | Activity | | | | | |
|---|---|---|---|---|---|---|---|---|
| | Boron | Hexene | (g PE/g | MI₂ | MI₅ | HLMI | SR₂ | SR₅ |
| ID | (Wt. %) | (Wt. %) | catalyst/hour) | (dg/min) | (dg/min) | (g/10 min) | (HLMI/MI₂) | (HLMI/MI₅) |
| A | 0.00 | 0.00 | 1,600 | 0.72 | 3.76 | 51.1 | 71 | 13.6 |
| B | 0.00 | 0.36 | 1,700 | 1.53 | 6.10 | 75.6 | 49 | 12.4 |
| C | 0.50 | 0.00 | 1,900 | 0.78 | 3.12 | 65.5 | 84 | 21.0 |
| D | 0.50 | 0.36 | 1,800 | 2.36 | 8.66 | 119.1 | 50 | 13.8 |
| E | 1.00 | 0.00 | 1,800 | 1.22 | 4.97 | 74.9 | 61 | 15.0 |
| F | 1.00 | 0.36 | 2,100 | 2.23 | 8.37 | 104.5 | 47 | 12.5 |

Molecular weight values were also obtained in order to determine the polydispersity. The results are shown in Table 3.

TABLE 3

| | | | | | | | MWD |
|---|---|---|---|---|---|---|---|
| | Boron | Hexene | Mn | Mw | Mz | Mp | (Mw/ |
| ID | (Wt. %) | (Wt. %) | (g/mol) | (g/mol) | (g/mol) | (g/mol) | Mn) |
| A | 0.00 | 0.00 | 12,160 | 180,420 | 2,530,097 | 36,880 | 14.8 |
| B | 0.00 | 0.36 | 11,020 | 149,813 | 2,233,181 | 33,285 | 13.6 |
| C | 0.50 | 0.00 | 10,837 | 152,367 | 2,585,217 | 31,816 | 14.1 |
| D | 0.50 | 0.36 | 10,704 | 121,768 | 1,533,513 | 30,415 | 11.4 |
| E | 1.00 | 0.00 | 9,710 | 133,471 | 1,891,857 | 30,415 | 13.7 |
| F | 1.00 | 0.36 | 10,604 | 148,955 | 2,693,661 | 31,818 | 14.0 |

The results show in general that molecular weight distribution (MWD) is, overall, approximately the same as or slightly narrower when the chromium catalyst is modified using triethyl boron, prior to its activation. This is in marked contrast to what is seen with use of triethyl boron as a cocatalyst in the prior art wherein polydispersity increases markedly as triethyl boron concentration increases. The results also show that shear response values rise initially, but then decrease as boron level increases as illustrated in the changes in the SR2 and SR5 values for Sample IDs A, C, and E; and B, D, and F.

### Example 2

### Aluminum and Boron Modification

The precursor sample used in Example 1 was dried under a nitrogen purge and the dried precursor sample was then treated with a boron treating agent, an aluminum treating agent or a combined boron and aluminum treating agent by contacting the precursor with a 1M solution of triethyl boron, triethyl aluminum, or a mixture of triethyl boron and triethyl aluminum, in hexane in order to achieve levels of boron incorporation equal to 1.0 weight percent, aluminum levels of 2.5 percent and a combined level of 0.24 percent boron and 0.63 percent aluminum. The samples a control were then activated as in Example 1.

The modified catalysts and control were then used in a bench reactor polymerization using the conditions shown in Table 4.

TABLE 4

| Diluent | Isobutane |
|---|---|
| Target Productivity (g PE/g catalyst) | 1000 |
| Temperature (° C.) | 96, 100, 104 |
| Ethylene Concentration (Wt. %) | 8 |
| Hexene Concentration (Wt. %) | 0, 0.18, 0.36 |

The activity of the catalyst, measured as g PE/g catalyst/hr, was tested and compared with the level of hexene. Melt flow was also tested, as HLMI (ASTM D1238), MI₂ (2.16 kg weight-ASTM D1238) and MI₅ (5 kg weight-ASTM D1238). These results are shown in Table 5.

TABLE 5

| | | | | Activity | | | | | |
|---|---|---|---|---|---|---|---|---|---|
| | Boron | Al | Hexene | (g PE/g | MI₂ | MI₅ | HLMI | | |
| ID | (Wt. %) | (Wt %) | (Wt. %) | catalyst/hour) | (dg/min) | (dg/min) | (g/10 min) | SR₂ | SR₅ |
| G | 0.00 | 0.00 | 0.00 | 1,700 | 0.63 | 2.89 | 46.9 | 74 | 16.2 |
| H | 0.00 | 0.00 | 0.36 | 1,600 | 1.56 | 5.94 | 73.3 | 47 | 12.3 |
| I | 1.00 | 0.00 | 0.00 | 2,100 | 1.02 | 4.74 | 71.4 | 70 | 15.1 |
| J | 1.00 | 0.00 | 0.36 | 1,700 | 2.11 | 7.76 | 105.7 | 50 | 13.6 |
| K | 0.00 | 2.5 | 0.00 | 1,800 | 0.77 | 2.91 | 41.7 | 54 | 14.3 |
| L | 0.00 | 2.5 | 0.36 | 1,800 | 1.33 | 5.39 | 66.2 | 50 | 12.3 |
| M | 0.24 | 0.63 | 0.00 | 2,200 | 0.98 | 4.26 | 63.2 | 64 | 14.8 |
| N | 0.24 | 0.63 | 0.36 | 1,800 | 2.19 | 8.67 | 114.9 | 52 | 13.3 |

Molecular weight values were also obtained in order to determine the polydispersity. The results are shown in Table 6.

TABLE 6

| | | Reaction | | | | | | |
|---|---|---|---|---|---|---|---|---|
| | | Temp | Hexene | Mn | Mw | Mz | Mp | MWD |
| ID | Catalyst | (° C.) | (Wt. %) | (g/mol) | (g/mol) | (g/mol) | (g/mol) | (Mw/Mn) |
| A-A | Control | 104 | 0 | 11,463 | 146,603 | 1,625,048 | 36,391 | 12.8 |
| A-B | Control | 96 | 0.36 | 10,097 | 185,017 | 2,841,094 | 35,066 | 18.3 |
| A-C | Control | 104 | 0.36 | 11,407 | 122,622 | 1,176,683 | 33,949 | 10.7 |
| A-D | +1% B | 104 | 0 | 10,411 | 122,647 | 1,227,172 | 32,038 | 11.8 |
| A-E | +1% B | 96 | 0.36 | 9,489 | 152,482 | 2,291,444 | 30,294 | 16.1 |
| A-F | +1% B | 104 | 0.36 | 10,662 | 152,946 | 2,408,114 | 32,038 | 14.3 |
| A-G | +2.5% Al | 104 | 0 | 12,990 | 180,855 | 2,321,186 | 36,391 | 13.9 |
| A-H | +2.5% Al | 96 | 0.36 | 11,017 | 179,361 | 2,134,313 | 39,235 | 16.3 |
| A-I | +2.5% Al | 104 | 0.36 | 12,184 | 161,970 | 2,842,950 | 32,412 | 13.3 |

The results show in general that molecular weight distribution (MWD) is, overall, approximately the same as or slightly narrower when the chromium catalyst is modified using triethyl boron or aluminum, prior to its activation. This is in marked contrast to what may be seen with use of triethyl boron as a cocatalyst, wherein polydispersity increases markedly as triethyl boron concentration increases.

### Example 3 Boron Modification (II)

A silica titania chromium catalyst precursor was prepared and treated with a boron treating agent substantially similarly to Example 1 except that additional types of treating agents and more varied conditions were used. The conditions and the testing results are shown below in tables 7, 8A and 8B. The treatment agents used were triethyl boron (TEB), boric acid, trimethoxy borate (B(OMe)₃) and trimethylboroxine (B₃O₆Me₃).

TABLE 7
Table 1

| Diluent | Isobutane |
|---|---|
| Target Productivity (g PE/g catalyst) | 1000 |
| Temperature (° C.) | 96, 99, 100, 104 |
| Ethylene Concentration (Wt. %) | 8 |
| Hexene Concentration (Wt. %) | 0, 0.18, 0.36 |

Similar to the previous examples, the results displayed in Tables 8A and 8B show in general that molecular weight distribution (MWD) is, overall, approximately the same as or slightly narrower when the chromium catalyst is modified using a boron treatment agent prior to its activation. This is in marked contrast to what is seen with use of, for example, triethyl boron as a cocatalyst, wherein polydispersity increases markedly as triethyl boron concentration increases. Interestingly, the form of the boron treatment agent appears to have at least some impact on the effect of the treatment agent with TEB having the least effect and trimethoxy borate having the most effect. Of the two compounds having intermediate effect, boric acid was more effective than trimethylboroxine.

TABLE 8A

| | Catalyst | Catalyst | Reaction | wt % | Activity | MI2 | MI5 | HLMI | | |
|---|---|---|---|---|---|---|---|---|---|---|
| ID | Type | Amount | T (° C.) | Hexene | (g/g h) | (g/10 m) | (g/10 m) | (g/10 m) | SR2 | SR5 |
| B-A | Control | 350 | 96 | 0.36 | 1366 | 0.55 | 2.33 | 43.4 | 79 | 18.6 |
| B-B | | 350 | 100 | 0.36 | 1516 | 0.94 | 3.91 | 71.7 | 76 | 18.3 |
| B-C | | 350 | 104 | 0 | 1711 | 0.63 | 2.89 | 46.9 | 74 | 16.2 |
| B-D | | 350 | 104 | 0.18 | 1556 | 1.35 | 4.72 | 65.7 | 49 | 13.9 |
| B-E | | 350 | 104 | 0.36 | 1602 | 1.56 | 5.94 | 73.3 | 47 | 12.3 |
| B-F | +1% B | 350 | 96 | 0.36 | 1327 | 0.75 | 3.32 | 61.7 | 82 | 18.6 |
| | TEB | | | | | | | | | |
| B-G | | 300 | 100 | 0.36 | 1869 | 1.05 | 6.04 | 85.8 | 82 | 14.2 |
| B-H | | 350 | 104 | 0 | 2082 | 1.02 | 4.74 | 71.4 | 70 | 15.1 |
| B-I | | 300 | 104 | 0.18 | 1794 | 1.44 | 5.85 | 94.0 | 65 | 16.1 |
| B-J | | 300 | 104 | 0.36 | 1709 | 2.11 | 7.76 | 105.7 | 50 | 13.6 |
| B-K | +1% B | 300 | 96 | 0.36 | 1753 | 0.66 | 2.73 | 52.9 | 80 | 19.4 |
| | Boric Acid | | | | | | | | | |
| B-L | | 350 | 100 | 0.36 | 1713 | 1.42 | 5.24 | 79.3 | 56 | 15.1 |
| B-M | | 350 | 104 | 0 | 1844 | 1.15 | 4.43 | 63.1 | 55 | 14.2 |
| B-N | | 300 | 104 | 0.18 | 2126 | 1.89 | 7.04 | 102.0 | 54 | 14.5 |
| B-O | | 300 | 104 | 0.36 | 1997 | 2.47 | 9.06 | 112.5 | 46 | 12.4 |
| B-P | | 350 | 99 | 0 | 1539 | 0.62 | 2.56 | 42.7 | 69 | 16.7 |
| B-Q | +1% B | 300 | 96 | 0.36 | 1665 | 0.41 | 2.09 | 41.6 | 101 | 19.9 |
| | B(OMe)₃ | | | | | | | | | |
| B-R | | 300 | 100 | 0.36 | 1756 | 1.24 | 4.31 | 69.7 | 56 | 16.2 |
| B-S | | 350 | 104 | 0 | 1967 | 1.21 | 4.84 | 67.0 | 55 | 13.8 |
| B-T | | 300 | 104 | 0.18 | 1789 | 1.86 | 7.04 | 92.1 | 50 | 13.1 |
| B-U | | 300 | 104 | 0.36 | 1679 | 2.95 | 9.83 | 126.1 | 43 | 12.8 |
| B-V | +1% B | 300 | 96 | 0.36 | 1356 | 0.65 | 2.52 | 49.1 | 76 | 19.5 |
| | B₃O₆Me₃ | | | | | | | | | |
| B-W | | 300 | 100 | 0.36 | 1606 | 1.36 | 4.67 | 69.7 | 51 | 14.9 |
| B-X | | 350 | 104 | 0 | 1935 | 1.16 | 4.57 | 64.7 | 56 | 14.2 |
| B-Y | | 300 | 104 | 0.18 | 1545 | 1.60 | 6.06 | 84.4 | 53 | 13.9 |
| B-Z | | 300 | 104 | 0.36 | 1797 | 2.38 | 8.13 | 109.0 | 46 | 13.4 |

TABLE 8 B

| | Catalyst | Catalyst | Reaction | wt % | | | | | MWD |
|---|---|---|---|---|---|---|---|---|---|
| ID | Type | Amount | T (° C.) | Hexene | Mn | Mw | Mz | Mp | (Mw/Mn) |
| 1′ | Control | 350 | 96 | 0.36 | 10097 | 185017 | 2841094 | 35066 | 18.3 |
| 2′ | | 350 | 100 | 0.36 | 10540 | 142607 | 1444186 | 35972 | 13.5 |
| 3′ | | 350 | 104 | 0 | 11463 | 146603 | 1625048 | 36391 | 12.8 |
| 4′ | | 350 | 104 | 0.18 | 10942 | 152870 | 2208340 | 34744 | 14.0 |
| 5′ | | 350 | 104 | 0.36 | 11407 | 122622 | 1176683 | 33949 | 10.7 |
| 6′ | +1% B | 350 | 96 | 0.36 | 9489 | 152482 | 2291444 | 30294 | 16.1 |
| | TEB | | | | | | | | |
| 7′ | | 300 | 100 | 0.36 | 10117 | 142274 | 1715284 | 32411 | 14.1 |
| 8′ | | 350 | 104 | 0 | 10411 | 122647 | 1227172 | 32038 | 11.8 |
| 9′ | | 300 | 104 | 0.18 | 11150 | 156092 | 2496226 | 32789 | 14.0 |
| 10′ | | 300 | 104 | 0.36 | 10662 | 152946 | 2408114 | 32038 | 14.3 |
| 11′ | +1% B | 300 | 96 | 0.36 | 10808 | 188865 | 3036004 | 36230 | 17.5 |
| | Boric Acid | | | | | | | | |
| 12′ | | 350 | 100 | 0.36 | 11236 | 154143 | 2324650 | 33101 | 13.7 |
| | | 300 | 104 | 0.36 | 11434 | 125992 | 1921227 | 30581 | 11.0 |
| 13′ | +1% B | 300 | 96 | 0.36 | 11814 | 178034 | 2166176 | 38330 | 15.1 |
| | B(OMe)₃ | | | | | | | | |
| 14′ | | 300 | 100 | 0.36 | 11347 | 153715 | 2349015 | 34631 | 13.5 |
| 15′ | | 300 | 104 | 0.36 | 11804 | 124919 | 1985271 | 30581 | 10.6 |
| 16′ | +1% B | 300 | 96 | 0.36 | 10176 | 154003 | 2208567 | 34242 | 15.1 |
| | B₃O₆Me₃ | | | | | | | | |
| 17′ | | 300 | 100 | 0.36 | 10174 | 176167 | 2893533 | 32361 | 17.3 |
| 18′ | | 300 | 104 | 0.36 | 11293 | 133960 | 2003712 | 30929 | 11.9 |

What is claimed is:

1. A process for preparing a chromium pre-catalyst comprising admixing a chromium catalyst precursor with a treatment agent to form a pre-catalyst, wherein the treatment agent is selected from the group consisting of an aluminum treatment agent, a boron treatment agent, and mixtures thereof.

2. The process of claim 1 further comprising activating the precatalyst to form a catalyst.

3. The process of claim 2 wherein the precatalyst is activated using heat.

4. The process of claim 1 wherein the aluminum or boron treatment agent has the general formula: 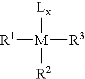
wherein:
M is aluminum or boron;
L is a Lewis base or an ammonium moiety;
X is 0 or 1;
R¹, R², and R³ are the same or different and independently selected from the group consisting of:
alkyl, aryl, and alkoxy moieties having from 3 to 15 carbons,
halogens,
hydroxy groups,
oxy groups, and
hydrogen;
provided that
when X=0 and M is aluminum, at least one of R¹, R², and R³ is not hydrogen; and
at least two or more of R¹, R², and R³ may be incorporated into a cyclic structure which may include additional aluminum or boron atoms.

5. The process of claim 4 wherein the treatment agent is an aluminum treatment agent.

6. The process of claim 5 wherein the aluminum treatment agent is a trialkyl aluminum compound.

7. The process of claim 6 wherein the aluminum treatment agent is selected from the group consisting of triethyl aluminum (TEAI), trimethyl aluminum (TMA) triisobutyl aluminum (TIBAI), tri-n-hexylaluminum, tri-n-octylaluminum, tri-iso-octylaluminum, triphenylaluminum, and mixtures thereof.

8. The process of claim 7 wherein the aluminum treatment agent is selected from the group consisting of triethyl aluminum (TEAI), triisobutyl aluminum (TIBAI), tri-n-octylaluminum, tri-iso-octylaluminum, and mixtures thereof.

9. The process of claim 7 wherein the aluminum treatment agent is triethyl aluminum (TEAI).

10. The process of claim 4 wherein the treatment agent is a boron treatment agent.

11. The process of claim 10 wherein the boron treatment agent is selected from the group consisting of: triethyl boron (TEB), boric acid, trimethoxy borate (B(OMe)₃), trimethylboroxine (B₃O₆Me₃), triphenyl boron, triethyl boron, trifluoroboron, triethoxy borate, triethylboroxine, Et₂OBH₃, and mixtures thereof.

12. The process of claim 11 wherein the boron treatment agent is triethyl boron.

13. The process of claim 1 wherein the treatment agent is a boron treatment agent comprised of boron hydride.

14. The process of claim 1 wherein the chromium catalyst precursor is a silica titania chromium catalyst precursor.

15. A process for preparing a polymer comprising:
contacting a chromium catalyst precursor with a treatment agent to form a precatalyst;
activating the precatalyst to form a chromium catalyst; and
contacting at least one monomer with the chromium catalyst to form a polymer, wherein the treatment agent is selected from the group consisting of an aluminum treatment agent, a boron treatment agent, and mixtures thereof.

16. The process of claim 15 wherein the at least one monomer is selected from the group consisting of ethylene; propylene; butene-1; pentene-1; 4-methyl-pentene-1; hexene-1; octene-1; decene-1,3-methyl-pentene-1; 3,5,5-trimethyl-hexene-1; cyclic olefins; vinyl monomers; diolefins; polyenes; norbornenes; norbornadienes; and combinations thereof.

17. The process of claim 16 wherein the at least one monomer is a combination of ethylene and hexene-1.

18. The process of claim 16 wherein the at least one monomer is ethylene.

19. The process of claim 15 wherein the treatment agent is an aluminum treatment agent selected from the group consisting of triethyl aluminum (TEAI), trimethyl aluminum (TMA), triisobutyl aluminum (TIBAI), tri-n-hexylaluminum, tri-n-octylaluminum, tri-iso-octylaluminum, triphenylaluminum, and mixtures thereof.

20. The process of claim 15 wherein the treatment agent is a boron treatment agent selected from the group consisting of: boron hydride, triethyl boron (TEB), boric acid, trimethoxy borate (B(OMe)₃), trimethylboroxine (B₃O₆Me₃), triphenyl boron, triethyl boron, trifluoroboron, triethoxy borate, triethylboroxine, Et₂OBH₃, and mixtures thereof.

21. The process of claim 15 wherein the polymer is polyethylene.

22. A polymer prepared by the process of claim 15.

23. An article of manufacture prepared from the polymer of claim 22.

24. The article of manufacture of claim 23 wherein the article is a film, molded article, sheet, or wire and cable coating.
